(19) United States
(12) Patent Application Publication
(10) Pub. No.: US 2006/0176134 A1
(43) Pub. Date: Aug. 10, 2006

(54) Ignition coil

(75) Inventor: Norihito Fujiyama, Obu-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/330,119

(22) Filed: Jan. 12, 2006

(30) Foreign Application Priority Data
Feb. 10, 2005 (JP) 2005-34536

(51) Int. Cl. H01F 27/02

(52) U.S. Cl. 336/90

(57) ABSTRACT

An ignition coil includes a cylindrical portion and an ion current detecting device. The cylindrical portion includes a primary coil and a secondary coil, which are coaxially wound and are adapted to be inserted into a plughole of an engine case. The cylindrical portion has a metal center core and a metal outer core at an outer periphery of the primary coil or the secondary coil. A cross-sectional area in a direction perpendicular to an axial direction of the cylindrical portion of the outer core is 105% or more of the cross-sectional area of the center core. Thereby, almost all of the magnetic flux of an inductive magnetic field that passes through the center core can pass through the outer core. Thus, a leak of the magnetic flux to an exterior can be restricted.

### CROSS REFERENCE TO RELATED APPLICATION

This application is based on and incorporates herein by reference Japanese Patent Application No. 2005-34536 filed on Feb. 10, 2005.

### TECHNOLOGICAL FIELD

Example embodiments of the technology described herein relate to an ignition coil for generating a spark in a spark plug. More particularly, the example embodiments of the technology relate to an ignition coil having an ion current detecting device.

### DESCRIPTION OF RELATED ART

An ignition coil is mounted of an internal combustion engine of a vehicle or the like. The ignition coil is electrically connected with a spark plug to generate a spark in a combustion chamber of a cylinder of the engine. When fuel is burned in the combustion chamber, fuel is ionized, so that ion current flows between electrodes of the spark plug. The ion current is detected by an ion current detecting device to evaluate whether miss fire arises in the combustion chamber.

In the ignition coil, a magnetic field is generated to pass through the center core and the outer core by instantaneous electricity transmission to a primary coil. When the electricity transmission to the primary coil is stopped, an inductive magnetic field is generated to pass through the center core and the outer core in a direction opposite to the magnetic field, so that the secondary coil generates induced electromotive force (counterelectromotive force) by the inductive magnetic field. Thus, the spark plug can generate a spark.

Remnants of the inductive magnetic field exist after the spark. There is a possibility that this magnetic noise is detected by the ion current detecting device, when ion current is detected. Therefore, ion current is detected after a predetermined time from the spark of the spark plug.

As disclosed for example in U.S. Pat. No. 5,866,808 (JP-A-09-195913) electric elements in an ion current detecting circuit are devised in order to stabilize detection of ion current. Moreover, as disclosed for example in JP-U-3028977, a cross-sectional area of an outer iron core (outer core) is within 75-100% of a cross-sectional area of a central iron core (center core) in order to increase an ignition energy in an ignition coil.

### SUMMARY OF EXAMPLE EMBODIMENTS OF THE PRESENT INVENTION

The above described ignition coils are insufficient to stabilize detection of ion current. In this regard, there is no thought to improve a detection accuracy of ion current by using a relation of a cross-section area of a center core and an outer core.

Example embodiments of the present invention resolve the foregoing matter and other problems. One aspect of example embodiments of the present invention is to produce an ignition coil that can improve a detection accuracy of ion current.

Thus, according to one aspect of the present invention, an ignition coil includes a cylindrical portion and an ion current detecting device. The cylindrical portion includes a primary coil and a secondary coil, with the secondary coil wound coaxially with respect to the primary coil. The cylindrical portion is capable of being inserted into a plughole of an engine case. The cylindrical portion has a metal center core at an inner periphery of the primary coil or the secondary coil. The cylindrical portion has a metal outer core at an outer periphery of the primary coil or the secondary coil.

A cross-sectional area in a direction perpendicular to an axial direction of the cylindrical portion of the outer core is about 105% or more of a cross-sectional area of the center core.

Thereby, almost all the magnetic flux of the inductive magnetic field that passes through the center core, can pass through the outer core, so that it can restrict a leak of the magnetic flux to an exterior ignition coil. Thus, it can restrict remnants of the inductive magnetic field from remaining in the exterior of ignition coil and from becoming magnetic noise, so that the ion current detecting device can certainly detect ion current while reducing a bad influence due to magnetic noise. Therefore, a detection accuracy of ion current can improve.

### BRIEF DESCRIPTION OF THE DRAWINGS

The present invention will be understood more fully from the detailed description given hereinafter and from the accompanying drawings of the example embodiments of the present invention, which, however, should not be taken to limit the present invention to the specific embodiments but are for the purpose of explanation and understanding only.

In the accompanying drawings:

FIG. 1 is a cross sectional side view showing an ignition coil according to an example embodiment of the present invention;

FIG. 2 is a cross sectional side view showing the ignition coil of FIG. 1 after being inserted into a plughole of an engine case;

FIG. 3 is a cross sectional top view showing the ignition coil of FIG. 1;

FIG. 4 is a schematic circuit showing an ion detecting circuit of the ignition coil;

FIG. 5 is a graph showing an output of ion current over time; and

FIG. 6 is a graph showing the detected time of magnetic noise in accordance with a ratio of cross-sectional area.

### DETAILED DESCRIPTION OF EXAMPLE EMBODIMENTS

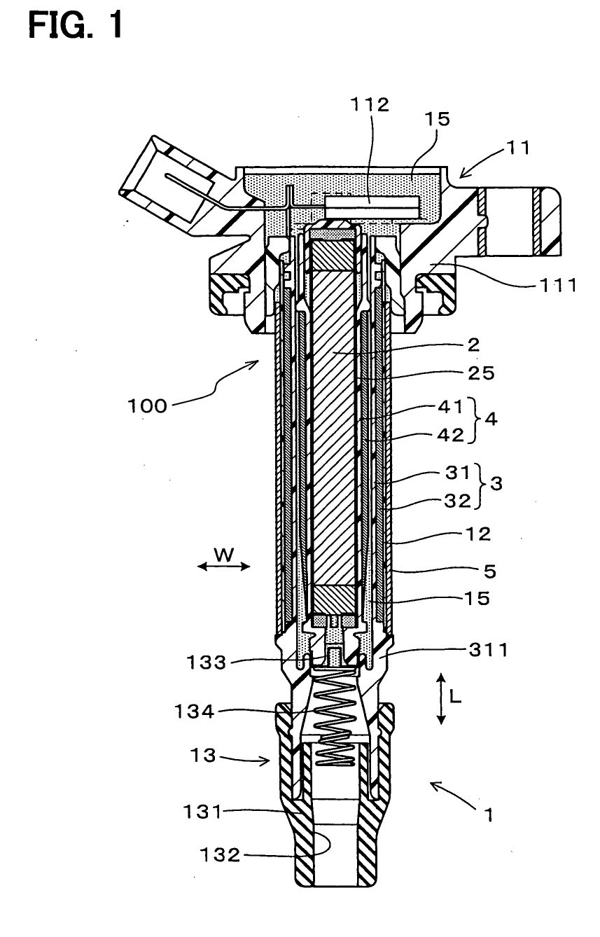

As shown in FIGS. 1-3, an ignition coil 1 is electrically connected with a spark plug 6 to generate a spark in a combustion chamber of a cylinder of an internal combustion engine. The ignition coil 1 includes a cylindrical portion 100, a plug attachment portion 13, and an ion current (ion current function) detecting device. The cylindrical portion 100 accommodates a primary coil 3 and a secondary coil 4 that are wound coaxially to each other. The cylindrical portion 100 is inserted into a plughole 71 of an engine case 7. The plug attachment portion 13 is attached to a spark plug 6.

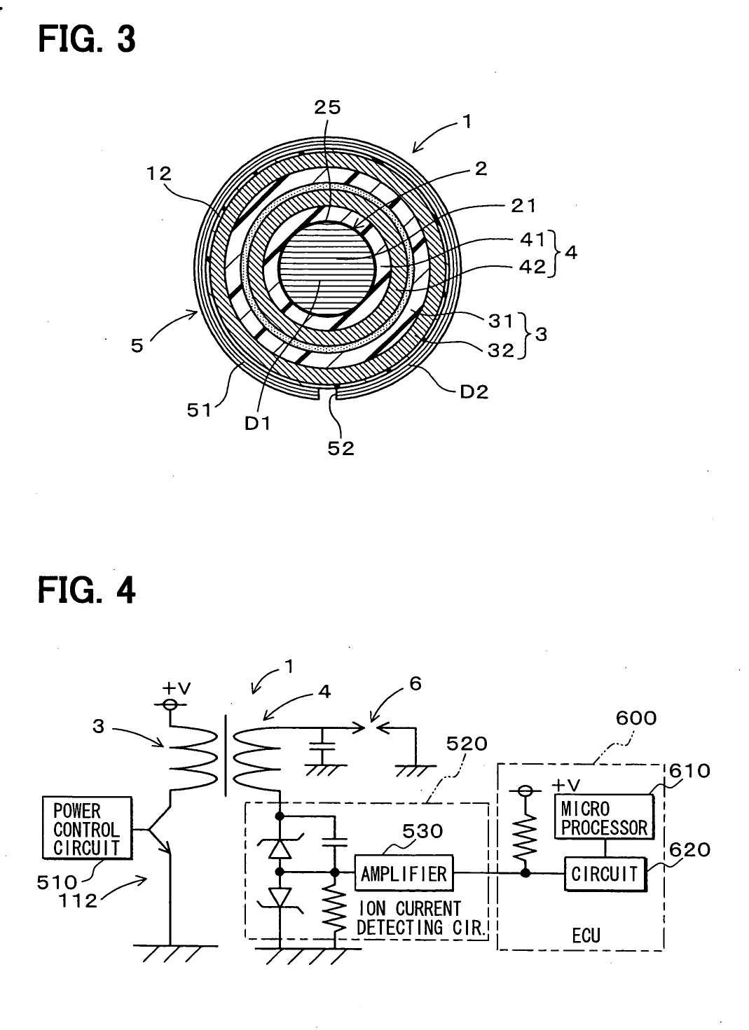

The cylindrical portion 100 includes a metal center core 2 and a metal outer core 5. The center core 2 is at an inner periphery of the primary coil 3 or the secondary coil 4. In a direction W, perpendicular to an axial direction of the cylindrical portion 100, a ratio (D2/D1) of a cross-sectional area (D2) of the outer core 5 to a cross-sectional area (D1) of the center core 2 is 105% or more, as discussed greater detail below with reference to FIG. 3.

Next, the structure of the ignition coil 1 is described in detail.

As shown in FIG. 1 and FIG. 3, the primary coil 3 is formed of a primary wire 32, which is coated with an electrically insulative material. The primary wire 32 of the primary coil 3 is wound around the outer periphery of a primary spool 31, which is cylindrical in shape.

The secondary coil 4 is formed of a secondary wire 42, which is coated with an electrically insulative material. The secondary wire 42 of the secondary coil 4 is wound around the outer periphery of a secondary spool 41, which is cylindrical in shape. The secondary wire 42 of the secondary coil 4 is wound for a number of turns that is greater than a number of turns of the primary coil 3.

The secondary coil 4 is inserted inside the inner periphery of the primary coil 3, so that the center core 2 is arranged on the inner peripheral side of the secondary coil 4. The primary coil 3 is inserted inside the inner periphery of a thin spool 12 which is cylindrical and formed of resin, so that the outer core 5 is arranged on the outer peripheral side of the thin spool 12.

As shown in FIG. 3, the center core 2 is formed from a plurality of laminated steel plates 21, such as silicon steel plates, that are laminated in a direction W perpendicular to an axial direction L (FIG. 1). The plurality of laminated steel plates 21 are a substantially stick-shape plate with an insulating material surface. The plurality of laminated steel plates 21 are combined by welding ends to each other.

The outer core 5 is formed from a plurality of cylindrical laminated steel plates 51, such as silicon steel plates, each having a slit (gap) 52 in the axial direction L. The plurality of cylindrical steel plates 51 are bonded to each other by adhesives in a radial direction.

The primary coil 3 is supplied with electricity, so that the primary coil 3 generates magnetic flux that passes through the center core 2 and the outer core 5. Therefore, the magnetic flux can be amplified in the ignition coil 1. An insulated sheet 25 for stress relaxation is twisted around the outer peripheral side of the center core 2.

Alternatively, the primary coil 3 is formed in the following manner without using the primary spool 31. That is, a primary wire, which is coated with an electrically insulative material, is wound to be in a cylindrical shape, subsequently the wound wires are bonded by binding medium or the like to be in a cylindrical shape.

As shown in FIG. 1, electrically insulative resin is filled in a gap formed between the center core 2 and the secondary coil 4, a gap formed between the secondary coil 4 and the primary coil 3, a gap formed between the primary coil 3 and the thin spool 12.

The plug attachment portion 13 has an extended portion 311 and a plug cap 131. The extended portion 311 is formed to extend the primary spool 31 toward the spark plug 6. The plug cap 131 made of rubber is attached to the extended portion 311. The plug cap 131 has a plug attachment hole 132 for attaching the spark plug 6. The extended portion 311 has a high voltage terminal 133 and coil spring 134. The coil spring 134 is electrically connected with the spark plug 6. The high voltage terminal 133 is electrically connected with one end (high voltage end) of the secondary coil 4. The coil spring 134 makes contact with the one end of the secondary coil 22 via the high voltage terminal 133.

The cylindrical portion 100 is attached to an igniter portion 11 on the opposite side of the plug attachment portion 13 in the axial direction L. The igniter portion 11 supplies electricity to the primary coil 3. The igniter portion 11 is not accommodated in the plughole 71 when the cylindrical portion 100 is inserted into the plughole 71.

The igniter portion 11 includes an igniter case 111 and an igniter 112. The igniter case 111 is attached to the cylindrical portion 100. The igniter case 111 is made of resin. The igniter 112 is mounted in the igniter case 111. The igniter case 111 is filled with electrically insulative resin in a condition, in which the igniter 112 is set in the igniter case 111. As shown in FIG. 4, the igniter 112 includes an electrical power control circuit 510 and an ion current detecting circuit 520. The electrical power control circuit 510 is operated by a signal transmitted from an electric control unit (ECU) 600. The ion current detecting circuit 520 detects ion current flowing between electrodes of the spark plug 6.

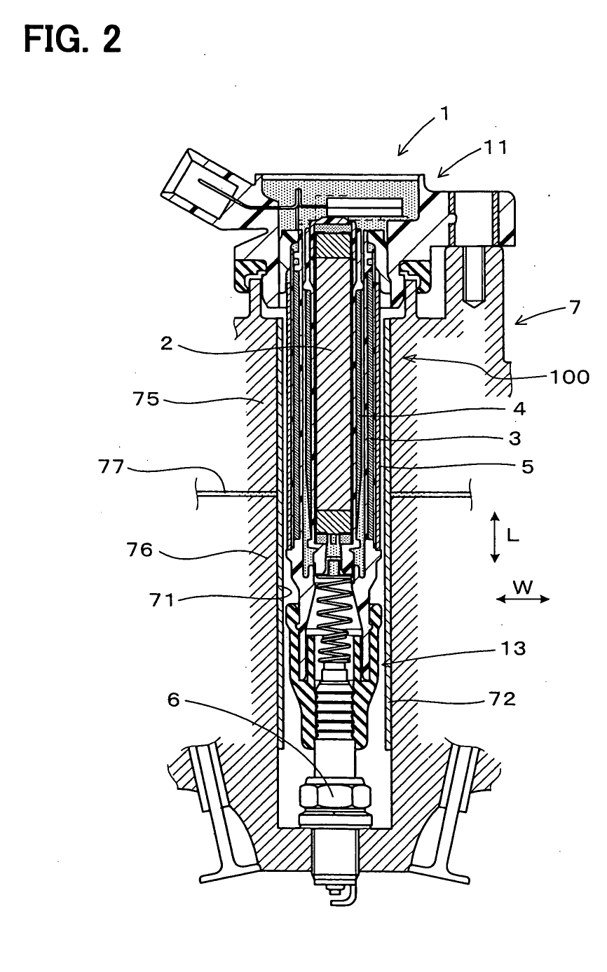

As shown in FIG. 2, the engine case 7 is made from aluminum, for example. The engine case 7 has an upper portion 75 and lower portion 76. The plughole 71 of the engine case 7 includes an iron tube 72. The iron tube 72 is fit to the inner periphery of the plughole 71. The iron tube 72 blocks a gap 77 formed between the upper portion 75 and the lower portion 76 or restrict oil ingress into the plughole 71.

The ignition coil 1 of the example embodiment has the outer diameter below 22 mm. Moreover, the outer diameter of the ignition coil 1 may be more than 18 mm.

As shown in FIGS. 1, 4, when the ECU 600 outputs a spark generating signal (pulse signal) to the igniter 112, a switching element in the igniter 112 introduces electricity that is transmitted to the primary coil 3, so that a magnetic field is generated to pass through the center core 2 and the outer core 5. When the electrical transmission to the primary coil 3 is stopped, an inductive magnetic field is generated to pass through the center core 2 and the outer core 5 in the direction opposite to the magnetic field, so that the secondary coil 4 generates induced electromotive force (counterelectromotive force) by the inductive magnetic field. Thus, the spark plug 6 can generate a spark.

When combustion is normally performed in the engine, the ingredient contained in fuel is ionized, so that ion current flows between the electrodes of the spark plug 6. As shown in FIG. 4, the ion current is transmitted from the spark plug 6 to the ion current detecting circuit 520, and is amplified using an amplifier 530 to be an ion current signal. The ion current signal is transmitted from the amplifier 530 to a processing circuit 620 such as a signal converter, so that the ion current signal is input from the processing circuit 620 to the ECU 610. Thus, it can be evaluated whether combustion is normal in the combustion chamber of the engine by detecting ion current with the ion current detecting device.

After the spark, remnants of the inductive magnetic field exist in a magnetic circuit of the center core 2 and the outer core 5.

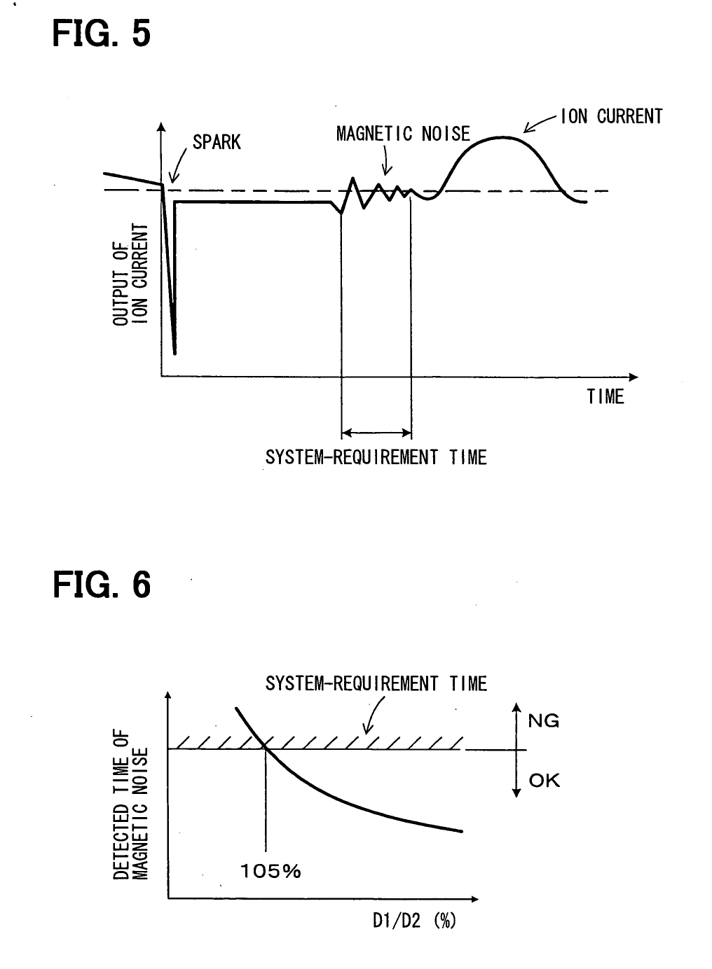

As shown in FIG. 5, in order to reduce detecting noise (magnetic noise) when ion current is detected by the ion current detecting device, the ECU requests the ion current detecting device to detect ion current after a predetermined time from the spark of the spark plug 6. The predetermined time is set up as system-requirement time in the ECU. Therefore, if magnetic noise remains after the system-requirement time passes, the ion current detection accuracy becomes worse.

In addition, FIG. 5 is a graph showing an output of ion current (vertical axis) over time (horizontal axis), and shows a change of the output of ion current.

On the other hand, in an example embodiment of the present invention, the magnetic flux of the inductive magnetic field passes through the center core 2 thereby restricting the magnetic flux from leaking to an exterior outer core 5, so that any influence of magnetic noise is decreased when ion current is detected.

That is, in the example embodiment, the cross-sectional area (D2) of the outer core 5 is about 105% or more of the cross-sectional area (D1) of the center core 2, so that almost all of the magnetic flux of the inductive magnetic field that passes through the center core 2 can pass through the outer core 5. Thus it can restrict a leak of the magnetic flux to an exterior magnetic circuit of the center core 2 and the outer core 5.

Therefore, it can effectively restrict the magnetic flux, which leaks to the exterior of the magnetic circuit, from permeating into the iron tube 72 in the plughole 71. Even when a hole of the aluminum engine case 7 with iron tube 72 is used as the plughole 71 into which the ignition coil 1 is inserted, the magnetic flux can be restricted from leaking to the iron tube 72 from the magnetic circuit due to the magnetic permeability of iron being higher than that of aluminum.

Therefore, according to the ignition coil 1 of the example embodiment, after the system-requirement time passes, magnetic noise can be restricted from exerting a bad influence on detection of ion current. Therefore, the detection accuracy of ion current can be effectively improved.

In the example embodiment, as the ratio (cross-sectional area ratio D2/D1) of the cross-sectional area (D2) of the outer core 5 to the cross-sectional area (D1) of the center core 2 is changed, a time period from a moment at which magnetic noise begins to be detected to a moment at which magnetic noise is almost undetectable was examined. FIG. 6 is a figure showing detected time of magnetic noise (vertical axis) in accordance to the cross-sectional area ratio (D2/D1 (%)) (horizontal axis), and shows a change in the detected time of magnetic noise. As shown in FIG. 6, it has been discovered that as the cross-sectional area of the outer core 5 becomes larger, the time period, in which the magnetic noise is detected, becomes shorter.

The ratio (cross-sectional area ratio D2/D1) of the cross-sectional area (D2) of the outer core 5 to the cross-sectional area (D1) of the center core 2 require 105% or more so that magnetic noise is substantially undetectable after the system-requirement time.

In addition, if the ratio becomes larger, the reduction of magnetic noise becomes better. However, it is preferred that the ratio is less than 200% to restrict an excessive enlargement of an outer diameter of the ignition coil 1.

It is preferred that the ratio is 130% or more to further ensure a stable detection of ion current, and it is preferred that the ratio is lower than 170% to further restrict an enlargement of an outer diameter of the outer core 5.

The present invention should not be limited to the disclosed example embodiments, but may be implemented in other ways without departing from the spirit of the aspect.

What is claimed is:

1. An ignition coil comprising:
a cylindrical portion that includes a primary coil and a secondary coil, the secondary coil being wound coaxially with respect to the primary coil;
wherein the cylindrical portion is adapted to be inserted into a plughole of an engine case,
the cylindrical portion has a metal center core at an inner periphery of the primary coil or the secondary coil, and
the cylindrical portion has a metal outer core at an outer periphery of the primary coil or the secondary coil,
wherein a cross-sectional area of the outer core in a direction perpendicular to an axial direction of the cylindrical portion is about 105% or more of a cross-sectional area of the center core, so that magnetic noise is substantially reduced.

2. The ignition coil according to claim 1, wherein a cross-sectional area of the outer core is less than 200% of a cross-sectional area of the center core.

3. The ignition coil according to claim 1, wherein a cross-sectional area of the outer core is within 130-170% of a cross-sectional area of the center core.

4. The ignition coil according to claim 1, wherein magnetic noise is substantially reduced within a predetermined time following a spark of a spark plug of an engine.

5. The ignition coil according to claim 1, wherein the center core is formed from a plurality of laminated steel plates that are laminated in a direction perpendicular to the axial direction of the cylindrical portion.

6. The ignition coil according to claim 1, wherein the outer core is formed from a plurality of cylindrical laminated steel plates, each having a slit in the axial direction.

7. The ignition coil according to claim 6, wherein the plurality of cylindrical steel plates of the outer core are laminated to each other in a radial direction of the cylindrical portion.

8. An assembly comprising an ignition coil inserted into a plughole of an engine case, wherein the ignition coil includes:
a cylindrical portion that includes a primary coil and a secondary coil, the secondary coil being wound coaxially with respect to the primary coil;
the cylindrical portion has a metal center core at an inner periphery of the primary coil or the secondary coil, and
the cylindrical portion has a metal outer core at an outer periphery of the primary coil or the secondary coil, wherein a cross-sectional area of the outer core in a direction perpendicular to an axial direction of the cylindrical portion is about 105% or more of a cross-sectional area of the center core, so that magnetic noise is substantially reduced.

9. The assembly according to claim 8,
wherein the plughole has an iron tube at the inner periphery of the plughole, and
the cylindrical portion is inserted into the iron tube.

10. The assembly according to claim 8, wherein the engine case is made of aluminum.

11. An apparatus for detecting ion current in an internal combustion engine, comprising:
a spark plug; and
an ignition coil inserted into a plughole of an engine case for generating a spark in the spark plug, wherein the ignition coil includes,
a cylindrical portion that includes a primary coil and a secondary coil, the secondary coil being wound coaxially with respect to the primary coil;
the cylindrical portion has a metal center core at an inner periphery of the primary coil or the secondary coil, and
the cylindrical portion has a metal outer core at an outer periphery of the primary coil or the secondary coil, wherein a cross-sectional area of the outer core in a direction perpendicular to an axial direction of the cylindrical portion which is about 105% or more of a cross-sectional area of the center core, so that magnetic noise is substantially reduced; and
an ion current detecting device for detecting ion current generated by a burn in the internal combustion engine caused by a spark of the spark plug.

12. The apparatus according to claim 11,
wherein the plughole has an iron tube at the inner periphery of the plughole, and
the cylindrical portion is inserted into the iron tube.

13. The apparatus according to claim 11, wherein the engine case is made of aluminum.

14. A method for detecting ion current, the method comprising:
providing an ignition coil including:
a cylindrical portion that includes a primary coil and a secondary coil, the secondary coil being wound coaxially with respect to the primary coil;
the cylindrical portion has a metal center core at an inner periphery of the primary coil or the secondary coil, and
the cylindrical portion has a metal outer core at an outer periphery of the primary coil or the secondary coil, a cross-sectional area of the outer core in a direction perpendicular to an axial direction of the cylindrical portion which is about 105% or more of a cross-sectional area of the center core;
inserting the cylindrical portion of the ignition coil into a plughole of an engine and operatively coupling the ignition coil to a spark plug;
outputting a spark generating signal for generating a spark to the ignition coil;
generating a spark with the spark plug; and
detecting ion current with an ion current detector at a predetermined time following the spark, whereby magnetic noise is substantially undetectable by the ion current detector.
